(19) United States
(12) Patent Application Publication
(10) Pub. No.: US 2019/0132304 A1
(43) Pub. Date: May 2, 2019

(54) LOOPBACK VERIFICATION OF MULTI-FACTOR AUTHENTICATION

(71) Applicant: CA, Inc., New York, NY (US)

(72) Inventors: Linwood Overby, Raleigh, NC (US); Frederic Armand Honore Duminy, St. Charles, IL (US); Ronald James Colmone, Arlington Heights, IL (US); Brian Michael Emond, Bolingbrook, IL (US); Scott Andrew Fagen, Frisco, TX (US); Sai Swetha Gujja, Naperville, IL (US)

(21) Appl. No.: 15/800,289

(22) Filed: Nov. 1, 2017

(51) Int. Cl. H04L 29/06

(52) U.S. Cl. CPC H04L 63/083; H04L 2463/082; H04L 63/0853

(57) ABSTRACT

A user can authenticate with multiple factors to a security appliance and establish an authenticated connection with a TN3270 client to a TN3270 server on a first mainframe via the security appliance as a proxy. The security appliance records the port number of the proxied connection and associates the port number with the user identifier, as well as an indication that MFA was performed successfully. After an SNA session is established with a second mainframe that hosts the SNA application to be accessed, a security macro can resolve a logical unit name of the TN3270 client to the IP address of the security appliance and port number of the proxied connection. The second mainframe can send a request via a web interface to the IP address for verification that the MFA requirement was satisfied for the user identifier associated with the SNA session.

### BACKGROUND

The disclosure generally relates to the field of information security, and more particularly to authentication across systems.

A mainframe computer (mainframe) cannot easily be distinguished from other computing platforms in general terms. In general terms, a mainframe can be described with the same characteristics as a personal computer and a supercomputer: each includes a processor, memory, and a bus. These computing platforms diverge based on their hardware, which is designed for particular types of tasks. A mainframe typically includes hardware for reliably handling large numbers of input/output operations on large amounts of data, for supporting numerous concurrent users, and for running numerous programs concurrently. Tasks with these characteristics likely fall into a batch processing task category or online transaction processing (e.g., credit card transaction processing) task category.

The typical users of mainframes include large organizations (e.g., a government agency or large financial institution). An organization may have display devices or terminals for accessing mainframes, but terminal emulators have become more common. Similarly, organizations implemented Systems Network Architecture (SNA) networks to connect the terminals and mainframes but have incorporated Internet Protocol (IP) based networks into their infrastructure.

Along with this change came a transition from mainframe applications written for SNA and 3270 (“SNA applications”) to applications written for Transfer Control Protocol over IP (TCP/IP). The Telnet 3270 protocol facilitated this transition and was eventually enhanced into the TN3270E, although both are referred to as TN3270. Organizations still have SNA networks and SNA applications, but a tn3270 client (a TN3270 emulator that communicates over a TCP/IP connection) cannot directly access the SNA applications. To connect to an SNA application, a TN3270 client may connect to a TN3270 server running on a first mainframe that converts the connection protocol of the TN3270 client into a SNA compliant communication. Access to the SNA application is obtained via a Virtual Telecommunications Access Method (VTAM) server, which is the networking software used by the mainframe operating system for communicating over SNA networks.

### BRIEF DESCRIPTION OF THE DRAWINGS

Embodiments of the disclosure may be better understood by referencing the accompanying drawings.

FIG. 1 is a conceptual diagram of loopback verification of multi-factor authentication for a SNA application.

FIG. 2 is a conceptual diagram illustrating example loopback MFA verification interactions within a mainframe hosting a target application.

FIG. 3 is a flowchart of example operations for verifying remote MFA for an application or loopback verification.

FIG. 4 depicts an example mainframe with a loopback MFA verification macro.

### DESCRIPTION

The description that follows includes example systems, methods, techniques, and program flows that embody embodiments of the disclosure. However, it is understood that this disclosure may be practiced without these specific details. In other instances, well-known instruction instances, protocols, structures and techniques have not been shown in detail in order not to obfuscate the description.

### INTRODUCTION

The factors for multi-factor authentication (MFA) generally fall into the categories of knowledge (e.g., password), possession (e.g., smart card), and inherence (e.g., fingerprint). The motivation for MFA is that an unauthorized actor is less likely to obtain multiple of these factors. Security policies increasingly require MFA to access resources, such as mainframe applications. In the context of mainframe clusters, one of the multiple factors is likely possession (e.g., common access card (CAC) or personal identity verification (PIV) card). In the case of a mainframe cluster with SNA applications accessed from TN3270 clients via intermediaries (TN3270 server and VTAM server), the application may be subject to a policy that requires multi-factor authentication. However, a resource manager of the SNA application will not have visibility of authentication at the remote machine hosting the TN3270 client.

Overview

A resource manager or security module on a mainframe that hosts an SNA application can verify that users attempting to access the SNA application have been successfully authenticated according to an MFA requirement of the SNA application despite lacking initial visibility of the authentication. A user can authenticate with multiple factors to a security appliance and establish an authenticated connection with a TN3270 client to a TN3270 server via the security appliance as a proxy. The security appliance records the port number of the proxied connection and associates the port number with the user identifier, as well as an indication that MFA was performed successfully. After an SNA session is established with the mainframe that hosts the SNA application to be accessed, a macro instruction can be invoked to resolve a logical unit name of the TN3270 client to the IP address of the security appliance and port number of the proxied. A security program on the mainframe can verify that the IP address identifies a trusted security appliance, and then send a request via a web interface to the IP address for verification that the MFA requirement was satisfied for the user identifier associated with the SNA session. Thus, the resource manager or security module can determine whether MFA for an SNA application was successful despite a lack of visibility to the initial authentication by looping back to the initial authenticating security appliance with the proxied connection information.

Example Illustrations

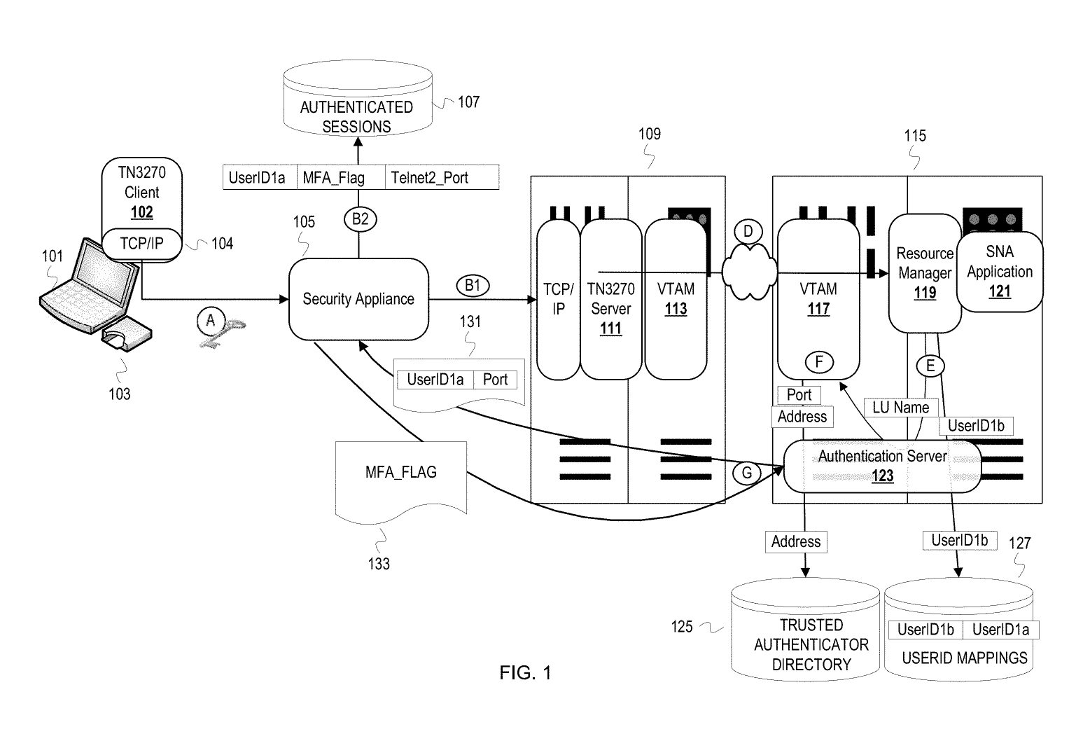

FIG. 1 is a conceptual diagram of loopback verification of MFA for a SNA application. The illustrated system includes a general purpose computer 101 communicatively coupled with a security appliance 105. The security appliance 105 is communicatively coupled with a mainframe 109. The mainframe 109 is communicatively coupled with a mainframe 115. The general purpose computer 101 is connected to a smart card reader 103. FIG. 1 is annotated with a series of letters that represent stages of operations. Each stage may correspond to one or multiple operations performed by elements depicted in FIG. 1. In this illustration, a user is authenticated according to MFA with a smart card at the general purpose computer and attempts to access an SNA application 121 on a mainframe 115 that is removed from the initial authentication point (i.e., the smart card reader 103).

At stage A, an authenticated connection is established with the security appliance 105. The smart card reader 103 verifies that a user has a smart card based on insertion of the smart card into the reader 103 and verifies that a pin number entered matches the pin stored on the smart card (i.e., performs MFA). If the pin number matches, the smart card reader 103 either communicates a certificate or a value read from the certificate to the security appliance 105. Assuming the value or the certificate is valid, an authenticated connection is established with the security appliance 105.

At stages B1-B2, the security appliance 105 stores information for loopback verification of the MFA and proxies a connection to the mainframe 109. A user opens a TN3270 client 102 to establish a 3270 session. The TN32770 client 102 may be launched from an applet provided by the security appliance 105 based on authentication with the security appliance 105 or selected from available emulators on the computer 101. The TN3270 client 102 uses network program code 104 that implements TCP/IP to support the 3270 session. The request from the TN3270 client 102 to establish the session includes parameters specifying that the security appliance 105 is to operate as a proxy and connect to a TN3270 server 111 on the mainframe 109. At stage B1, the security appliance 105 establishes a TCP/IP connection with the TN3270 server 111. The source IP address and port number for the proxied TN3270 session is the IP address and port number of the security appliance 105. This information is carried forward through the subsequent session establishment. At stage B2, the security appliance 105 creates an entry in a store 107 (e.g., database, table, or key-value store) of authenticated sessions. The security appliance 105 creates the entry with the user identifier that has been authenticated (“UserID1a”), a flag indicating that the user identifier has been authenticated according to MFA, and a port number of the proxied connection from the security appliance 105 to the TN3270 server 111. Although stages B1 and B2 are described as discrete stages, the corresponding operations can be interleaved. For instance, the security appliance 105 may create the entry in the storage 107 with the authenticated user identifier and flag before establishing the proxied connection and then write the port number of the proxied connection into the entry after establishing the connection.

At stage D, the user attempts to access the SNA application 121 on the mainframe 115. After the security appliance 105 proxies the 3270 session with the TN3270 server 111 on the mainframe 109, the TN3270 client 102 transmits a request to log in to the SNA application 121 via the established 3270 session. This request identifies the SNA application 121 with an application identifier, which the TN3270 server 111 communicates to a VTAM instance 113. The VTAM instance 113 determines that the SNA application 121 is hosted on the mainframe 115 and establishes a SNA session with a VTAM instance 117 on the mainframe 115. For the SNA session, the VTAM instance 113 has a role of VTAM client while the VTAM instance 117 has the role of VTAM server. The VTAM instances 113, 117 communicate to establish the SNA session as an LU-LU session (i.e., a session between logical units—a logical unit being a particular category of network addressable unit in SNA). The VTAM server 117 stores information about LU-LU session that assigns the TN3270 client 102 as the secondary LU in the LU-LU session and the SNA application 121 as the primary LU. Designation of an LU as primary or secondary assigns different error recovery responsibilities. Storing the information includes the VTAM server 117 associating the port number of the proxied connection, which has been propagated forward in the requests that traversed the TN3270 server 111 and the VTAM instance 113, with the secondary LU name. For the primary LU, the VTAM server 117 associates the SNA application identifier with the name of the primary LU.

At stage E, a resource manager 119 that manages resources, including applications, on the mainframe 115 invokes a security macro instruction to determine whether access should be granted to the SNA application 121. After establishing the LU-LU session, a resource manager 119 pushes a login interface for the SNA application 121 back to the TN3270 client 102. A user will enter credentials in the login interface that include a user identifier and a password or passticket. The resource manager 119 then invokes a security macro instruction that includes the user identifier provided for the login interface of the SNA application (“UserID1b”), the application identifier, and the name of the secondary LU.

At stage F, invocation of the security macro instruction causes an authentication server 123 on the mainframe 115 resolve the secondary LU name back to other identifying information of the secondary LU—the port number of proxied connection and the IP address of the entity that established the connection with the mainframe 109. The authentication server 123 requests information from the VTAM server 117 for the LU name indicated in the security macro instruction. The VTAM server 117 returns a port number and an IP address. The authentication server 123 accesses a trusted authenticator directory 125 to validate the IP address as assigned to a trusted authenticator. The trusted authenticator 125 will have been configured in advance with IP addresses of devices that can be trusted by the mainframe 115. The authentication server 123 also accesses USER ID mappings 127, which may be maintained in a database, store, etc. Since the user identifier used to login to the SNA application 121 may be different than the user identifier used to login to the security appliance 105, the authentication server 123 determines a user identifier that maps to UserID1b in the mappings 127. As with the trusted devices, mappings of user identifiers across different system, application domains, and/or security domains is done in advance. In this illustration, the authentication server 123 maps UserID1b to UserID1a. With the resolved user identifier, port, and address, the authentication server 123 can request verification that the user requesting access to the SNA application 121 was authenticated according to MFA required for the SNA application 121.

At stage G, the authentication server 123 communicates with the storage appliance 105 to verify that MFA was satisfied for accessing the SNA application 121. The authentication server 123 creates a request 131 that indicates UserID1a and the port number that was associated with the secondary LU according to the VTAM server 117. The authentication server 123 communicates the request 131 to the network address that was associated with the secondary LU according to the VTAM server 117. The security appliance 105 accesses the authenticated sessions store 107 based on the UserID1a and the port number indicated in the request 131 to determine whether MFA was performed. This is indicated in FIG. 1 with the MFA_Flag. The security appliance 105 then creates a response 133 with the MFA_Flag or a value/code based on the MFA_Flag to the authentication server 123. If the response verifies that MFA was successful, then access to the SNA application 121 is granted.

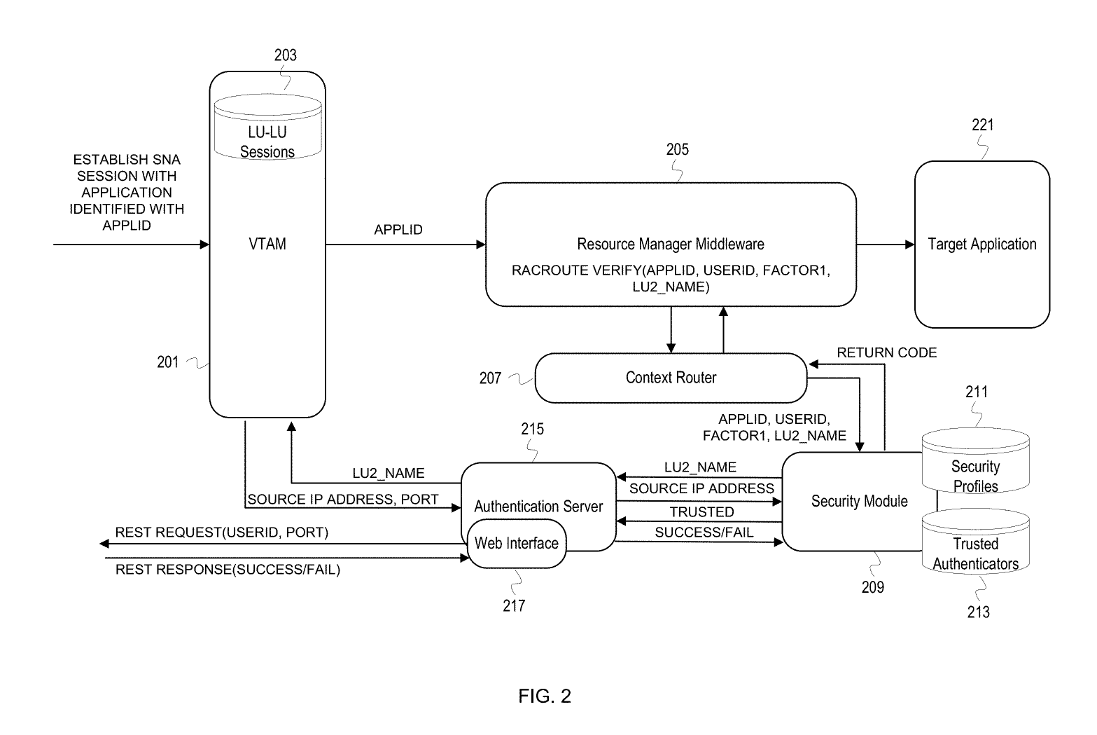

FIG. 2 is a conceptual diagram illustrating example loopback MFA verification interactions within a mainframe hosting a target application. This illustration includes a VTAM instance 201, resource manager middleware 205, a context router 207, a security module 209, an authentication server 215, and a target application 221. The illustration depicts the information exchanged between the programs on hosting mainframe for loopback MFA verification.

As discussed in FIG. 1, the VTAM instance 201 maintains information about SNA sessions established with the VTAM instance 201. In FIG. 2, the VTAM instance 201 records information about LU-LU sessions in a data structure or data store 203. The request to establish the LU-LU session includes an identifier of the target application 221, which is “APPLID” in this illustration. The VTAM instance 203 communicates the application identifier to the resource manager 205.

The resource manager middleware 205 is a set of programs that maintain information facilitates connectivity between applications on the mainframe and/or across a mainframe cluster. For instance, a customer information control system (CICS) can register with the VTAM instance 203 This includes the resource manager mapping application identifiers to execution spaces on the mainframe. In addition, the resource manager middleware 205 can manage access to applications by transferring control to a security module or an instance of the resource access control facility (RACF). In this illustration, the security macro RACROUTE VERIFY has been inserted into the resource manager middleware 205. The parameters of the macro instruction include the application identifier, a user identifier, an authentication factor (e.g., password to login to the target application 221), and a LU name. Collection of parameter arguments were already discussed in FIG. 1. Invocation of this security macro instruction transfers control to the context router 207, which determines a program to carry out the instructions/commands for the macro instruction as defined in a definition of the macro instruction. In this case, the context router 207 determines that the security module 209 is invoked for the security macro instruction (“macro”) and passes the parameter arguments of the macro to the security module 209 or indicates location of the parameter arguments to the security module 209.

The security module 209 accesses security profiles 211 to determine the security requirements of an application identified by APPLID (i.e., the target application 221). A security profile will specify the factors required for authentication of a user. The security module 209 determines whether the FACTOR1 is a valid factor for authentication for the target application 221. The security profile for the target application 221 indicates additional factors not yet satisfied, so the security manager 209 passes the LU name LU2_Name to the authentication server 215.

The authentication server 215 submits a VTAM DISPLAY LUNAME command via an interface for the VTAM instance 201. The command includes LU2_Name as an argument. In response, the VTAM instance 201 accesses the LU-LU sessions 203 with LU2_name, and returns a source IP address and port number associated with the LU2_Name via the VTAM interface to the authentication server 215. The authentication server 215 returns the source IP address to the security module 209 to determine whether the IP address is for a device trusted for authentication. The security module 209 accesses a storage 213 of trusted authenticators to determine whether the IP address is indicated as trusted, and returns an indication of trusted to the authentication server 215. The trusted IP addresses can be stored in various arrangements that allow accessing based on the IP address. Assuming an arrangement consists of records, each record is created in advance with information for communicating with the devices corresponding to the trusted IP addresses. Each record associates a trusted IP address with an identifier of a secure port for communicating with the device having the trusted IP address and with indication of one or more authentication factors to be authenticated by the trusted device.

Based on an indication from the security module 209 that the IP address is a trusted IP address, the authentication server creates to be transmitted via a web interface 217. For example, the authentication server 215 creates a representational state transfer (REST)ful request that indicates the port number associated with LU2_Name and UserID1a. The authentication server 215 then sends the RESTful request to the IP address via the secure port (e.g., a hypertext transfer protocol secure (HTTPS) port) associated with the trusted IP address in the store 213.

The device corresponding to the trusted IP address will send a RESTful response to the authentication server 215 that indicates whether a connection represented by the port number and UserID1a indicated in the request was authenticated with the one or more authentication factors indicated for the trusted IP address in the store 213. The authentication server 215 returns to the security module 209 a return code to indicate the success/failure of the MFA authentication process based on the response. The security module 209 completes the RACROUTE call with an appropriate return code based on the return code from the authentication server 215.

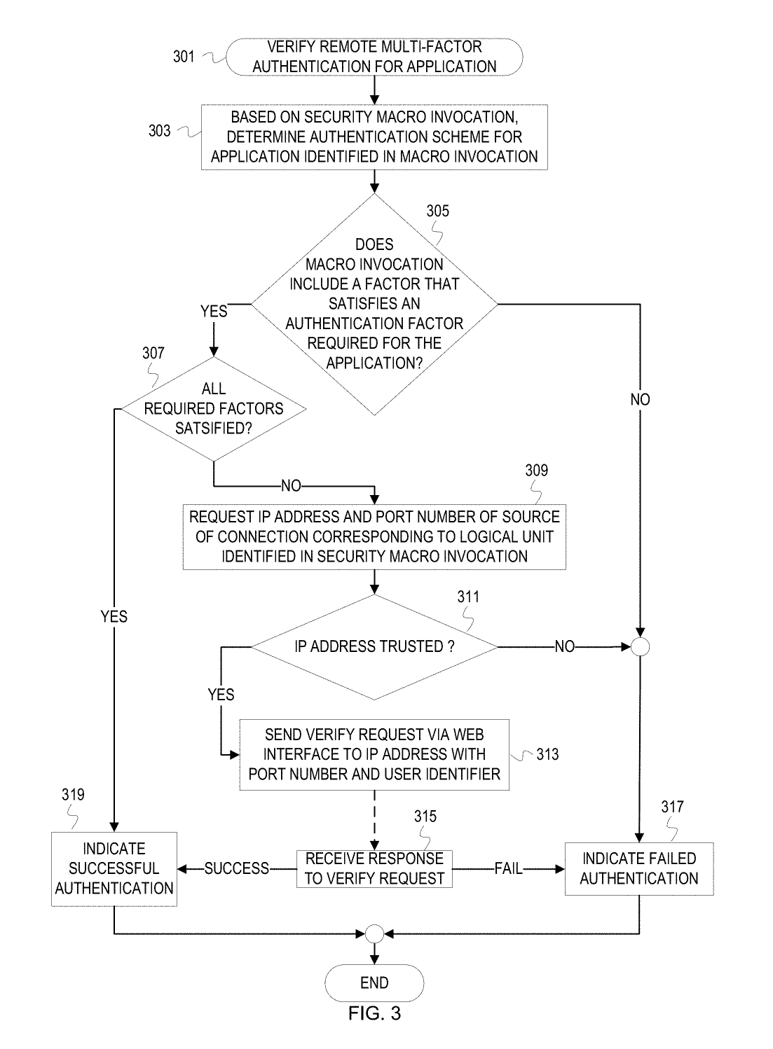

FIG. 3 is a flowchart of example operations for verifying remote MFA for an application or loopback verification. The description of FIG. 3 refers to a security module performing the operations. The security module can be program code installed on a mainframe from a third party independent of the mainframe manufacturer, can be program code of middleware installed on the mainframe, etc.

At block 303, a security module determines an authentication scheme specified for an application identified in a macro invocation. The security module can access access control facilities or programs of a mainframe to determine factors required for authentication to the application identified in the macro invocation. The security module can access or invoke another program or operating system process to determine authentication factors defined in a security profile for the identified application.

At block 305, the security module determines whether the macro invocation includes a factor that satisfies an authentication factor required for the application. The macro invocation can include a factor, such as a password, ticket, or token, that is provided as part of attempting to access the application after an initial, authenticated client session has already been established with a mainframe other than the mainframe that hosts the identified application. The factor included in the macro invocation is of a type indicated in the security profile, the security module can evaluate the factor or pass it to another program/process (e.g., authentication server) for evaluation to determine whether the factor indicated in the macro invocation is valid for the requesting user and the identified application. If the included factor does not satisfy any of the specified authentication factors (i.e., is not valid), then control flows to block 317. Otherwise, control flows to block 307. However, the user identifier and the authentication factor included in the macro invocation may not be specific to the application. The user identifier may be for logging into the mainframe that hosts the identified application (i.e., logging into the operating system of the mainframe). In that case, the macro invocation may not include the authentication factor for logging into the mainframe. But the user identifier for logging into the mainframe may still be mapped back to the user identifier of the authenticated TN3270 session. If the authentication factor logging into the mainframe fails, then the security macro is not invoked because access to the mainframe is denied.

At block 307, the security module determines whether all of the required factors are satisfied. If the security profile for the identified application only requires the factor included in the security macro, then all required factors are satisfied. If the security profile indicates additional authentication factors, then the security module proceeds to trace the LU corresponding to the requestor back to an authenticated session that satisfies the required factors. If all required factors are satisfied with the factor included in the macro, then control flows to block 319. Otherwise, control flows to block 309.

At block 309, the security module requests an IP address and port number of a source of a session corresponding to a logical unit identified in the macro invocation. The security module can request that another module or program determine this information as previously described. A VTAM or other communications management service/process can determine, on behalf of the security module, the source identifying information associated with the LU identified in the macro invocation.

At block 311, the security module determines whether the IP address associated with the identified LU is trusted. As previously described, the security module can access configuration or security information previously created. Each entry of the configuration information indicates a trusted IP address, one or more factors trusted to be verified by the device at the trusted IP address, and communication information for communicating with the device. The communication information can specify a protocol to use, a secure port, etc. If the IP address is trusted, then control flows to block 313. Otherwise, control flows to block 317.

At block 313, the security module sends a verify request via a web interface to the trusted IP address. The verify request includes as arguments the port number associated with the LU identified in the macro invocation and a user identifier. The user identifier may be the same as the user identifier used to establish the initial authenticated connection. More likely, the security module will resolve a user identifier used in attempting to access the identified application to a user identifier for a security appliance.

At block 315, the security module receives a response to the verify request. The dashed line from block 313 to 315 indicates the asynchronous/stateless flow from sending the request to receiving a response. If the response indicates that the authentication at the trusted device was successful, then control flows to block 319 where the security module indicates successful satisfaction of authentication to the identified application. If the response indicates that the authentication at the trusted device was not successful, then control flows to block 317 where the security module indicates failure of the attempted authentication to the identified application. The response may indicate failure because no entry was found for the combination of the port and user identifier in the request.

Variations

Although the examples describe a security appliance as handling the initial authentication and capturing information that identifies the authenticated connection, embodiments are not so limited. Embodiments can install program code on a mainframe that accepts authentication information without an intermediary security appliance. For instance, a TN3270 server on the mainframe can authenticate a user over a direct transport layer security (TLS) session between the mainframe and the claimant machine (i.e., machine at which the user is attempting access). The TN3270 server would include program code to capture the information that represents the authenticated session (i.e., port number, user identifier, and an indication that the MFA was successful). The TN3270 server could use a repository service of the mainframe to store and maintain the captured information for authenticated direct sessions. In this case, the TN3270 server operates as the trusted verifier. Thus, the store or list of trusted IP addresses would include an IP address of the mainframe associated with the TN3270 server.

The above examples presume that the authentication factors that can be verified by a trusted device satisfy the MFA scheme required for an application. Embodiments can perform additional operations to determine that the authentication factors that can be verified by a trusted device satisfy the MFA scheme required for an application. For example, an entry in a database or store of trusted devices can indicate a list of authentication factors that the device can be trusted to verify or a group of trusted devices can be indicated as trusted to verify a list of authentication factors. As another example, an entry can indicate a tag or reference value that resolves to a list of authentication factors. Embodiments can compare the authentication factors required for an application against the list that can be verified by a trusted device. If the required authentication factors are not satisfied, then the request to access the application can be denied or indicate an error without sending the communication to the trusted device.

The example illustrations depict the proxied connection from the client traversing an intermediary mainframe before connecting to the mainframe that hosts the target application. Embodiments are no limited to traversing an intermediary mainframe. The TN3270 server, VTAM instances, and target application may reside on a same mainframe. As one example, the TN3270 server and target application may be in different logical partitions of the mainframe.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

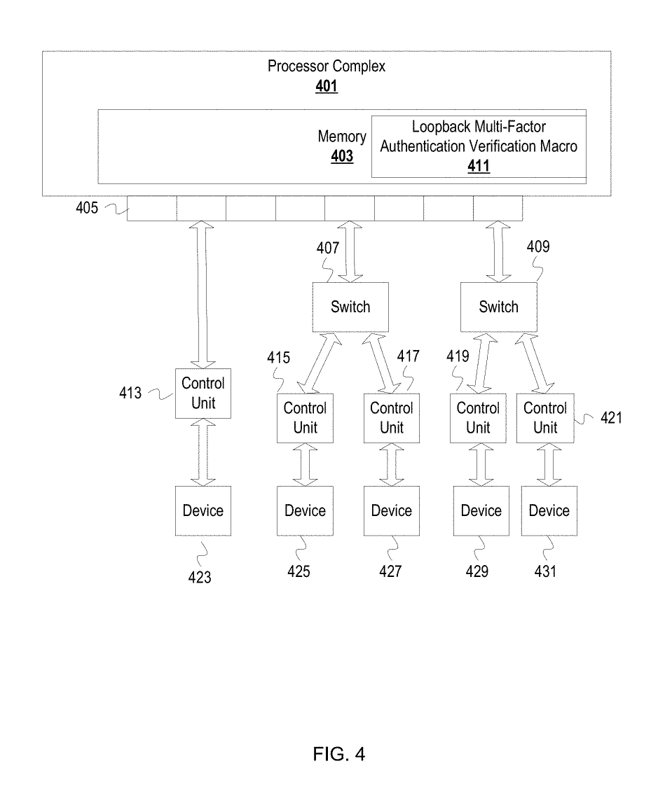

FIG. 4 depicts an example mainframe with a loopback MFA verification macro. The mainframe includes a processor complex 401, which is comprised of multiple processors. Each of the processors can be single core, multi-core, single threaded, multithreaded, etc. The processor complex includes main memory/storage 403. The main memory 403 comprises a macro 411 for loopback MFA verification which interlocks an authentication point remote from the mainframe with an authentication mechanism on the mainframe. The macro 411 represents a macro definition that includes multiple statements/commands to carry out the previously described technique for loopback MFA verification. A macro instruction for the macro definition is written into control points for verification before access to a secured application is allowed, such as in a resource manager. Through a plurality of input/output channels 405, the processor complex 401 received input and provides output to a control unit 413, a switch 407, and a switch 409. The control unit 413 interfaces with a device 423. The switch 407 interfaces with control units 415, 417. The control unit 415 interfaces with a device 425 and the control unit 417 interfaces with a device 427. The switch 409 interfaces with control units 419, 421. The control unit 419 interfaces with a device 429 and the control unit 421 interfaces with a device 431.

While the aspects of the disclosure are described with reference to various implementations and exploitations, it will be understood that these aspects are illustrative and that the scope of the claims is not limited to them. In general, techniques for authenticating a claimant according to MFA at an initial session with a first mainframe and verifying that MFA for an application on a second mainframe as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

This description uses the term “security appliance” to refer to a machine configured with hardware and software to specifically perform security related tasks. In contrast to a general purpose computer, a security appliance can include hardware and software devoted to authentication, encryption, etc.

This description also uses the term “authentication server” to refer to program code that may be a third party program(s) or operating system code of a mainframe that interfaces with multiple services/facilities of a mainframe to carry out authentication. This can include submitting commands via a VTAM interface and receiving results via the VTAM interface. Submitting requests to ACF2 or RACF and receiving responses accordingly.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
determining multiple authentication factors required for accessing an application on a first mainframe based, at least in part, on establishment of a session with the first mainframe to access the application, wherein the session is between a first logical unit corresponding to a client and a second logical unit corresponding to the application;
obtaining, from a communications management service on the first mainframe, a network address and a port number associated with a name of the first logical unit;
determining whether the network address is indicated as trusted;
based on a determination that the network address has been indicated as trusted, generating a request that indicates the port number associated with the logical unit name and a first user identifier corresponding to the client and communicating the request to the network address; and
based on a determination that a response to the request indicates that the multiple authentication factors were verified by a device for a connection corresponding to the first user identifier and the port number, indicating that access to the application is allowable, wherein the device corresponds to the network address.

2. The method of claim 1, wherein the first mainframe received the port number based, at least in part, on establishment of the session, wherein the session conforms to the Systems Network Architecture protocol.

3. The method of claim 1, wherein the port number is a port number for a proxied connection from the device and the proxied connection is for an authenticated connection from the client to the device.

4. The method of claim 3, wherein the client is a TN3270 client and the proxied connection from the device to a TN3270 server.

5. The method of claim 3 further comprising determining that a second user identifier maps to the first user identifier, wherein the second user identifier was supplied for login to the first mainframe and corresponds to the session.

6. The method of claim 5, wherein a credential supplied for login to the first mainframe with the second user identifier does not satisfy any one of the multiple authentication factors.

7. The method of claim 1 further comprising, based on a determination that the network address has been indicated as trusted, determining secure communication information for the network address, wherein communicating the request to the network address is based on the secure communication information.

8. The method of claim 1 further comprising, based on a determination that the network address has been indicated as trusted, determining an indication of a plurality of authentication factors indicated as verifiable by a device identified by the network address and determining that the plurality of authentication factors at least includes the multiple authentication factors required for the application.

9. The method of claim 1 further comprising invoking a macro instruction to determine whether multi-factor authentication has been satisfied for the application, wherein the macro instruction includes as arguments the first user identifier and the logical unit name, wherein the macro instruction is invoked based on attempted access to the application.

10. One or more non-transitory machine-readable storage media comprising program code for loop back verification of multi-factor authentication, the program code to:
determine multiple authentication factors required for accessing an application on a first mainframe based, at least in part, on establishment of a session with the first mainframe to access the application, wherein the session is between a first logical unit corresponding to a client and a second logical unit corresponding to the application;
obtain, from a communications management service on the first mainframe, a network address and a port number associated with a name of the first logical unit;
determine whether the network address is indicated as trusted;
based on a determination that the network address has been indicated as trusted, generate a request that indicates the port number associated with the logical unit name and a first user identifier corresponding to the client;
communicate the request to the network address; and
based on a determination that a response to the request indicates that the multiple authentication factors were verified by a device for a connection corresponding to the first user identifier and the port number, indicate that access to the application is allowable, wherein the device corresponds to the network address.

11. The non-transitory machine-readable storage media of claim 10, wherein the first mainframe received the port number based, at least in part, on establishment of the session, wherein the session conforms to the Systems Network Architecture protocol.

12. The non-transitory machine-readable storage media of claim 10, wherein the port number is a port number for a proxied connection from the device and the proxied connection is for an authenticated connection from the client to the device.

13. The non-transitory machine-readable storage media of claim 12, wherein the client is a TN3270 client and the proxied connection from the device to a TN3270 server.

14. The non-transitory machine-readable storage media of claim 12 further comprising program code to determine that a second user identifier maps to the first user identifier, wherein the second user identifier was supplied for login to the first mainframe and corresponds to the session.

15. The non-transitory machine-readable storage media of claim 14, wherein a credential supplied for login to the first mainframe with the second user identifier does not satisfy any one of the multiple authentication factors.

16. The non-transitory machine-readable storage media of claim 10 further comprising program code to determine secure communication information for the network address, based on a determination that the network address has been indicated as trusted, wherein communicating the request to the network address is based on the secure communication information.

17. A system comprising:
a security appliance comprising a processor and a machine-readable medium having stored therein program code executable by the processor to cause the security appliance to store a first user identifier in association with a port number of a proxied connection and an indication that an authenticated connection corresponding to the proxied connection was authenticated according to a multi-factor authentication requirement, wherein the first user identifier corresponds to the authenticated connection;
a mainframe comprising a processor complex and machine-readable medium having stored therein program code executable by at least one processor unit of the processor complex to cause the second mainframe to,
based on a request to access an application on the mainframe via the proxied connection, determine that access to the application is subject to the multi-factor authentication requirement;
determine a network address and a port number associated with a name of a first logical unit of a session between the first logical unit which corresponds to a client of the authenticated connection and a second logical unit which corresponds to the application;
determine whether the network address is indicated as trusted in a store of trusted devices accessible to the mainframe;
based on a determination that the network address is indicated as trusted, generate a request that indicates the port number associated with the name of the first logical unit and that indicates a first user identifier corresponding to the authenticated connection;
communicate the request to the network address; and
based on a determination that a response to the request indicates that the multi-factor authentication requirement was verified by a device at the network address, indicate that access to the application is allowable.

18. The apparatus of claim 17, wherein the security appliance further comprises program code executable by the processor to cause the security appliance to:
access a store of authenticated connections with the security appliance, based on receipt of a request a request for verification of multi-factor authentication;
determine whether an entry in the store includes a user identifier and a port number indicated in the received request; and
based on a determination that an entry in the store includes the user identifier and the port number in the request, determine whether the entry indicates that multi-factor authentication was performed successfully.

19. The apparatus of claim 17, wherein the mainframe further comprises program code executable by at least one processor unit of the processor complex to cause the mainframe to determine, based on a determination that the network address is indicated as trusted in the store of trusted devices, authentication factors verifiable by a device corresponding to the network address and secure communication information.

20. The apparatus of claim 17, wherein the program code of the mainframe to communicate the request to the network address comprises the program code executable by at least one processor unit of the processor complex to communicate the request based on the secure communication information.
